(19) United States
(12) Patent Application Publication
(10) Pub. No.: US 2026/0287608 A1
(43) Pub. Date: Sep. 24, 2026

(54) SPECIMEN ANALYSIS APPARATUS, DISPENSING APPARATUS, AND SPECIMEN ANALYSIS METHOD

(71) Applicant: CANON MEDICAL SYSTEMS CORPORATION, Otawara-shi (JP)

(72) Inventor: Shin IIDA, Ota (JP)

(73) Assignee: CANON MEDICAL SYSTEMS CORPORATION, Otawara-shi (JP)

(21) Appl. No.: 19/554,803

(22) Filed: Mar. 3, 2026

(30) Foreign Application Priority Data
Mar. 24, 2025 (JP) 2025-048724

(51) Int. Cl. G01N 35/10

(52) U.S. Cl. CPC G01N 35/1065; G01N 35/1002; G01N 35/1011; G01N 35/1016; G01N 2035/1034

(57) ABSTRACT

A specimen analysis apparatus according to an embodiment includes a first probe, a second probe and processing circuitry. The first probe aspirates a liquid biological sample from a sample container in which the biological sample is contained and dispenses the aspirated biological sample. The second probe aspirates a liquid reagent from a reagent container in which the reagent is contained and dispenses the aspirated reagent. The processing circuitry controls the first probe such that the biological sample is dropped into a water-repellent concave portion and controls the second probe such that the reagent is dropped into the concave portion.

### CROSS-REFERENCE TO RELATED APPLICATIONS

This application is based upon and claims the benefit of priority from Japanese Patent Application No. 2025-048724, filed Mar. 24, 2025, the entire contents of which are incorporated herein by reference.

### FIELD

Embodiments described herein relate generally to a specimen analysis apparatus, a dispensing apparatus, and a specimen analysis method.

### BACKGROUND

In an automatic analysis apparatus for clinical examination, a predetermined amount of biological sample (hereinafter, referred to as “sample”) such as blood or urine is mixed with a predetermined amount of reagent to cause a reaction, and the mixture is irradiated with light to measure the amount of transmitted light or scattered light of the irradiated light. Based on this measurement, the automatic analysis apparatus calculates the concentration or the activity value of the measurement target substance or calculates the time required for the change in concentration and activity value.

However, in conventional techniques, when the amount of liquid to be stirred is small, the liquid may not be sufficiently stirred.

### BRIEF DESCRIPTION OF THE DRAWINGS

FIG. 1 is a diagram illustrating a configuration example of an analysis apparatus according to an embodiment.

FIG. 2 is a diagram illustrating a configuration example of a dispensing unit according to the embodiment.

FIG. 3 is a flowchart illustrating a process performed by processing circuitry according to the embodiment.

FIG. 4 is a diagram schematically illustrating a state of mixing of a sample and a reagent.

FIG. 5 is a diagram illustrating an example of a method for adjusting a distance L.

### DETAILED DESCRIPTION

A specimen analysis apparatus according to an embodiment includes a first probe, a second probe, and processing circuitry. The first probe aspirates a liquid biological sample from a sample container in which the biological sample is contained and dispenses the aspirated biological sample. The second probe aspirates a liquid reagent from a reagent container in which the reagent is contained and dispenses the aspirated reagent. The processing circuitry controls the first probe such that the biological sample is dropped into a water-repellent concave portion, and controls the second probe such that the reagent is dropped into the concave portion.

Various Embodiments will be described hereinafter with reference to the accompanying drawings.

### Configuration of Analysis Apparatus

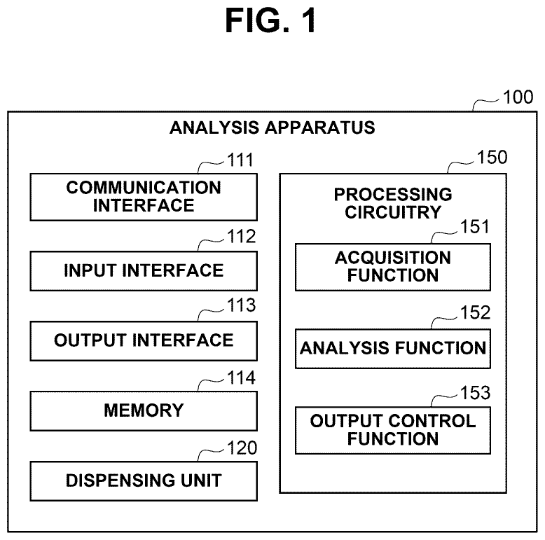

FIG. 1 is a diagram illustrating a configuration example of an analysis apparatus 100 according to an embodiment. The analysis apparatus 100 includes, for example, a communication interface 111, an input interface 112, an output interface 113, a memory 114, a dispensing unit 120, and processing circuitry 150. The analysis apparatus 100 is an example of a “specimen analysis apparatus” or a “dispensing apparatus”.

The communication interface 111 communicates with an external apparatus via a communication network NW. The communication network NW may refer to a general information and communication network using telecommunication technology. Examples of the communication network NW include a wireless/wired local area network (LAN) such as a hospital backbone LAN, the Internet, a telephone communication network, an optical fiber communication network, a cable communication network, and a satellite communication network. For example, the communication interface 111 includes a network interface card (NIC), and an antenna for wireless communication.

The input interface 112 receives various types of input operations from an operator, converts the received input operations into electrical signals, and outputs the electrical signals to the processing circuitry 150. For example, the input interface 112 includes a mouse, a keyboard, a trackball, a switch, a button, a joystick, a touch panel, and the like. The input interface 112 may be, for example, a user interface that receives audio input, such as a microphone. In a case where the input interface 112 is a touch panel, the input interface 112 may also serve as a display function of a display included in the output interface 113, which will be described below.

In the present specification, the input interface 112 is not limited to an interface including physical operating components such as a mouse and a keyboard. For example, electrical signal processing circuitry that receives electrical signals corresponding to input operations from an external input device provided separately from the analysis apparatus 100 and outputs the electrical signals to control circuitry is also an example of the input interface 112.

The output interface 113 includes, for example, a display, a speaker, and the like. The display displays various types of information. For example, the display displays an image generated by the processing circuitry 150, a graphical user interface (GUI) for receiving various types of input operations and the like from the operator. For example, the display is a liquid crystal display (LCD), a cathode ray tube (CRT) display, an organic electro luminescence (EL) display, or the like. The speaker outputs information received from the processing circuitry 150 as audio.

The memory 114 is implemented by, for example, a semiconductor memory element such as a random access memory (RAM) or a flash memory, a hard disk, or an optical disc. Such a non-transitory storage medium may be implemented by another storage device, such as a network attached storage (NAS) or an external storage server device, connected via the communication network NW. The memory 114 may include a non-transitory storage medium such as a read-only memory (ROM) and a register. The memory 114 stores programs executed by a hardware processor of the processing circuitry 150, various types of calculation results obtained by the processing circuitry 150, and the like.

The dispensing unit 120 is a group of devices and instruments that mix a sample and a reagent by causing them to react, and further measure characteristics of the resulting mixture.

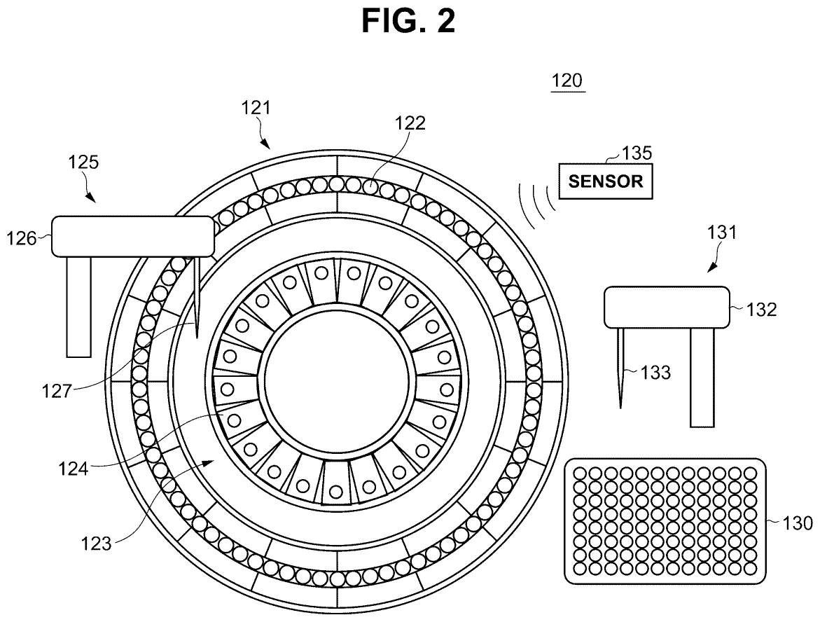

FIG. 2 is a diagram illustrating a configuration example of the dispensing unit 120 according to the embodiment. The dispensing unit 120 includes, for example, a reaction disk 121, a plurality of reaction vessels 122, a reagent storage table 123, a plurality of reagent containers 124, a reagent dispensing probe 125, a plurality of sample containers 130, a sample dispensing probe 131, and a sensor 135.

The reaction disk 121 is formed in, for example, an annular shape and holds the plurality of reaction vessels 122. For example, the reaction disk 121 rotates about a rotational axis such that the plurality of reaction vessels 122 arranged along a circumference centered on the rotational axis are moved on the circumference.

The reaction vessels 122 are, for example, tubular containers, each of which has a water-repellent concave portion formed on its bottom surface. A reagent is dispensed from a reagent container 124 into a reaction vessel 122, and a sample is dispensed from a sample container 130 into the reaction vessel 122. In the reaction vessel 122, the reagent and the sample are mixed.

The reagent storage table 123 is installed, for example, on the inner side of the reaction disk 121, which is formed in an annular shape, and holds the plurality of reagent containers 124. For example, the reagent storage table 123 rotates about the same rotational axis as the reaction disk 121 such that the plurality of reagent containers 124 arranged along the circumference centered on the rotational axis are moved on the circumference.

For example, each of the plurality of reagent containers 124 stores a different type of liquid reagent. Each reagent contains a component that reacts with a component contained in a sample. The individual reagent container 124 may have a bottle shape or a polyethylene tank (a water container) shape, for example.

The reagent dispensing probe 125 aspirates a reagent from a reagent container 124 (hereinafter, referred to as the target reagent container 124) containing the reagent to be reacted with a sample, among the plurality of reagent containers 124 on the reagent storage table 123, and then dispenses the aspirated reagent into a reaction vessel 122 on the reaction disk 121. The reagent dispensing probe 125 includes an arm 126 and a probe tip 127, which is inserted into the target reagent container 124 and comes into contact with the liquid surface of the reagent. The reagent dispensing probe 125 is an example of a “second probe”.

The arm 126 may be, for example, an arm having six degrees of freedom (6 DoF). For example, the arm 126 may move the reagent dispensing probe 125 in the vertical directions (up and down directions) and in the horizontal directions (front and back directions and left and right directions) under the control of the processing circuitry 150. Further, the arm 126 may rotate the reagent dispensing probe 125 about each of the three axes of the orthogonal coordinate system under the control of the processing circuitry 150.

The probe tip 127 includes a capacitance sensor. This capacitance sensor detects a change in capacitance as it comes into contact with the liquid surface of the reagent. For example, in a case where the change in capacitance detected by the capacitance sensor is equal to or greater than a threshold, it is determined that the probe tip 127 has come into contact with the liquid surface of the reagent.

For example, each of the plurality of sample containers 130 stores a different type of liquid sample. Each sample is typically a biological specimen such as blood, urine, saliva, or mucus. However, the sample is not limited thereto. For example, the sample may be any industrial specimen such as a pharmaceutical product, a chemical product, a semiconductor product, or an agrichemical product, or may be a specimen collected for a water quality survey of a river or an ocean. The type of the sample is not particularly limited. When the sample is a biological specimen such as blood, urine, saliva, or mucus, the analysis apparatus 100 according to the embodiment is particularly an example of a “specimen analysis apparatus”. In addition, when the sample is not limited to a biological specimen, the analysis apparatus 100 according to the embodiment is particularly an example of a “dispensing apparatus”.

The shapes and number of the sample containers 130 are not particularly limited. The sample containers 130 may be, for example, tubular containers placed in respective wells on a well plate or on a rack, or may be a plurality of containers arranged on the circumference of an annular disk or a table as described above.

The sample dispensing probe 131 aspirates a sample from a sample container 130, and dispenses the aspirated sample into a reaction vessel 122 on the reaction disk 121. The sample dispensing probe 131 includes an arm 132 and a probe tip 133, which is inserted into the sample container 130 and comes into contact with the liquid surface of the sample. The sample dispensing probe 131 is an example of a “first probe”.

The arm 132 may be, for example, an arm having 6 DoF. For example, the arm 132 may move the sample dispensing probe 131 in the vertical directions (up and down directions) and in the horizontal directions (front and back directions and left and right directions) under the control of the processing circuitry 150. Further, the arm 132 may rotate the sample dispensing probe 131 about each of the three axes of the orthogonal coordinate system under the control of the processing circuitry 150.

The probe tip 133 includes a capacitance sensor. This capacitance sensor detects a change in capacitance as it comes into contact with the liquid surface of the sample. For example, in a case where the change in capacitance detected by the capacitance sensor is equal to or greater than a threshold, it is determined that the probe tip 133 has come into contact with the liquid surface of the sample.

The sensor 135 irradiates light onto a reaction vessel 122, into which a sample and a reagent have been dispensed, and detects transmitted light or scattered light of the irradiated light.

Referring to the description of FIG. 1, the processing circuitry 150 has, for example, an acquisition function 151, an analysis function 152, and an output control function 153. The processing circuitry 150 implements these functions by, for example, a hardware processor (a computer) executing programs stored in the memory 114 (storage circuitry). The processing circuitry 150 is an example of “processing circuitry”.

The hardware processor in the processing circuitry 150 refers to, for example, circuitry such as a central processing unit (CPU), a graphics processing unit (GPU), an application specific integrated circuit (ASIC), or a programmable logic device (for example, a simple programmable logic device (SPLD), a complex programmable logic device (CPLD), or a field programmable gate array (FPGA)). Instead of storing the programs in the memory 114, the programs may be directly embedded into the circuitry of the hardware processor. In this case, the hardware processor implements the functions by reading out and executing the programs embedded in the circuitry. The programs may be stored in advance in the memory 114, or may be stored in a non-transitory storage medium such as a digital versatile disc (DVD) or a compact disc read-only memory (CD-ROM), and installed into the memory 114 from the non-transitory storage medium when the non-transitory storage medium is mounted on a drive device (not illustrated) of the analysis apparatus 100. The hardware processor is not limited to being configured as single circuitry, and may be configured by combining a plurality of independent circuitries into one hardware processor to implement the functions. Further, a plurality of components may be integrated into one hardware processor to implement the functions.

The acquisition function 151 acquires capacitance data indicating a change in capacitance at the probe tip 127 from the capacitance sensor of the reagent dispensing probe 125, and acquires capacitance data indicating a change in capacitance at the probe tip 133 from the capacitance sensor of the sample dispensing probe 131. The acquisition function 151 acquires light detection data indicating the transmitted light or the scattered light from the sensor 135.

The analysis function 152 controls the dispensing unit 120 to cause the sample and the reagent to react with each other and mix. Specifically, the analysis function 152 moves the probe tip 127 to the position of the target reagent container 124 by operating the arm 126. The analysis function 152 inserts the probe tip 127 into the target reagent container 124 by moving the reagent dispensing probe 125 downward.

The analysis function 152 determines whether the probe tip 127 has come into contact with the liquid surface of the reagent in the target reagent container 124 based on the capacitance data acquired from the capacitance sensor provided in the probe tip 127. When the probe tip 127 comes into contact with the liquid surface of the reagent, the analysis function 152 causes the probe tip 127 to aspirate the reagent.

The analysis function 152 moves the reagent dispensing probe 125 upward to remove the probe tip 127, which has aspirated the reagent, from the target reagent container 124. The analysis function 152 operates the arm 126 to move the probe tip 127 to the position of a reaction vessel 122 on the reaction disk 121, and causes the probe tip 127 to dispense the reagent into the reaction vessel 122.

The analysis function 152 moves the probe tip 133 to the position of a sample container 130 by operating the arm 132. The analysis function 152 inserts the probe tip 133 into the sample container 130 by moving the sample dispensing probe 131 downward.

The analysis function 152 determines whether the probe tip 133 has come into contact with the liquid surface of the sample in the sample container 130 based on the capacitance data acquired from the capacitance sensor provided in the probe tip 133. When the probe tip 133 comes into contact with the liquid surface of the sample, the analysis function 152 causes the probe tip 133 to aspirate the sample.

The analysis function 152 moves the sample dispensing probe 131 upward to remove the probe tip 133, which has aspirated the sample, from the sample container 130. The analysis function 152 operates the arm 132 to move the probe tip 133 to the position of the reaction vessel 122 on the reaction disk 121, and causes the sample dispensing probe 131 to dispense the sample into the reaction vessel 122. As a result, the sample and the reagent react with each other in the reaction vessel 122, and the mixture of the sample and the reagent is produced.

Typically, the analysis function 152 causes the sample dispensing probe 131 to dispense (drop) a sample into a reaction vessel 122, and subsequently causes the reagent dispensing probe 125 to dispense (drop) a reagent into the reaction vessel 122 in which the sample is present. However, this order may be reversed. That is, the analysis function 152 may cause the reagent dispensing probe 125 to dispense a reagent into a reaction vessel 122, and subsequently cause the sample dispensing probe 131 to dispense a sample into the reaction vessel 122 in which the reagent is present. Alternatively, both operations may be performed simultaneously.

The analysis function 152 controls the sensor 135 such that the reaction vessel 122, in which the mixture of the sample and the reagent is present, is irradiated with light. Based on the light detection data of the transmitted light or the scattered light, which has been acquired by the acquisition function 151, the analysis function 152 calculates the concentration or the activity value of the measurement target substance or calculates the time required for the concentration or the activity value to change. The type of light to be detected is not limited to transmitted light and scattered light, and may be, for example, luminescence. By detecting luminescence, the concentration or the activity value of the measurement target substance can also be calculated.

The output control function 153 outputs analysis result data indicating the concentration, the activity value, and/or the time calculated by the analysis function 152 via the output interface 113. For example, the output control function 153 may cause the display to display the analysis result data. The output control function 153 may transmit the analysis result data to an external apparatus (for example, a computer used by a researcher, an analyst, or the like) via the communication interface 111.

### Processing Flow of Analysis Apparatus

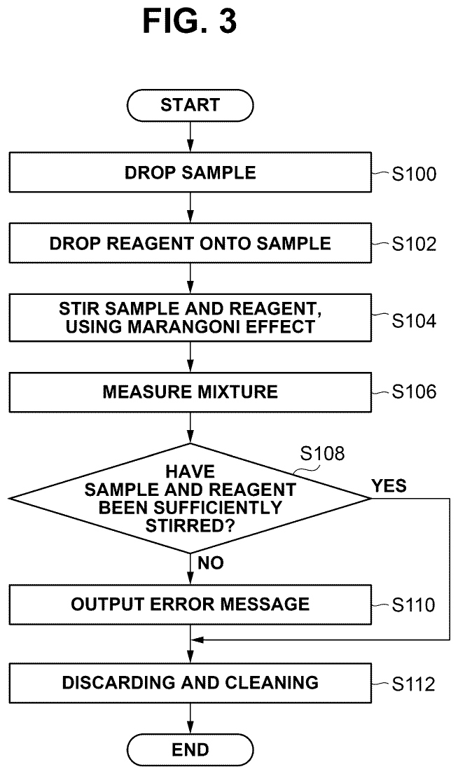

Hereinafter, a series of processes performed by the processing circuitry 150 of the analysis apparatus 100 will be described with reference to a flowchart. FIG. 3 is a flowchart illustrating the series of processes performed by the processing circuitry 150 according to the embodiment. The processing in this flowchart may be repeatedly executed, for example.

First, in step S100, the analysis function 152 controls the sample dispensing probe 131 such that a sample contained in a sample container 130 is dropped into a reaction vessel 122 having a water-repellent concave portion.

For example, the analysis function 152 causes the sample dispensing probe 131 to dispense the sample from the probe tip 133 such that a minute amount of sample is dropped into the reaction vessel 122. The minute amount may be, for example, a liquid volume of 7 microliters (μL) or less. In a case where such a volume of sample is dropped, the sample assumes a spherical shape, and can maintain high surface tension. That is, a minute amount of spherical sample is formed on the water-repellent concave portion. Here, the spherical shape is not limited to a perfect sphere. The spherical shape may include, for example, a sphere and a shape similar to a sphere that the sample or the reagent can assume due to surface tension when the sample or the reagent is present on a water-repellent concave portion or when the sample or the reagent is dropped.

Next, in step S102, the analysis function 152 controls the reagent dispensing probe 125 such that a reagent contained in the target reagent container 124 is dropped into the reaction vessel 122 into which the sample has already been dropped. That is, the analysis function 152 causes the reagent dispensing probe 125 to drop a reagent onto the sample in the reaction vessel 122.

For example, the analysis function 152 causes the reagent dispensing probe 125 to drop the reagent from the probe tip 127 such that a minute amount of reagent is dropped into the reaction vessel 122. As in the case of the sample, the minute amount of the reagent may be, for example, a liquid volume of 7 μL or less. In a case where such a volume of reagent is dropped, the reagent also assumes a spherical shape, and can maintain high surface tension. As a result, the minute amount of spherical reagent is dropped onto the minute amount of spherical sample.

In step S104, when the spherical reagent is dropped onto the spherical sample in the reaction vessel 122, the sample and the reagent are stirred by the Marangoni effect (Marangoni convention). As a result, a mixture of the sample and the reagent is produced.

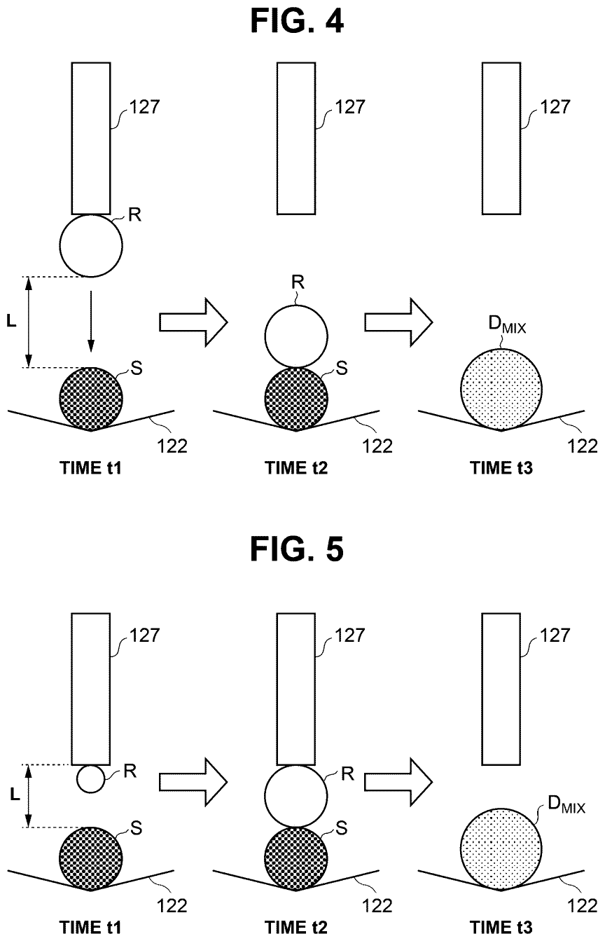

FIG. 4 is a diagram schematically illustrating the state of mixing of a sample and a reagent. In FIG. 4, “S” represents a sample, “R” represents a reagent, and “D_{MIX}” represents a mixture. “L” represents the shortest distance between the surface of the spherical sample S and the probe tip 127. For example, the distance L may be a distance at which the reagent R is prevented from scattering around.

As illustrated in FIG. 4, at time t1, a reagent R is dispensed from the probe tip 127 onto a spherical sample S formed on the concave portion in the reaction vessel 122. In this case, the analysis function 152 may adjust the amount of the reagent R to be dispensed from the probe tip 127 such that the diameter of the reagent R becomes the same as the diameter of the sample S.

At time t2 after time t1, the spherical reagent R is dropped onto the spherical sample S from the probe tip 127. As a result, the spherical sample and reagent, which have high surface tension, are brought into contact with each other. This effectively causes the Marangoni effect, thereby improving the stirring rate. As a result, at time t3 after time t2, a mixture D_{MIX}, in which the sample and the reagent have been sufficiently mixed, is produced.

The distance L has been described as a distance at which the reagent R is prevented from scattering around. However, the distance L is not limited to this distance. For example, the distance L may be adjusted to become the same length as the diameter of the reagent R.

FIG. 5 is a diagram illustrating an example of a method for adjusting the distance L. As illustrated in FIG. 5, the analysis function 152 controls the position (that is, the height) of the probe tip 127 of the reagent dispensing probe 125 in the vertical direction such that the distance L becomes the same length as the diameter of the reagent R. This makes it possible, for example, at time t2, to shorten the distance between the reagent R and the sample S to the extent that the reagent R and the sample S come into contact with each other when the reagent R is dispensed from the probe tip 127.

In general, the smaller the size of the reagent R is, the more difficult it becomes for the reagent R to separate from the probe tip 127. This is because surface tension becomes more dominant than gravity. Thus, by bringing the probe tip 127 close to the sample S until the distance between the probe tip 127 and the sample S becomes the same as the diameter of the reagent R to be dispensed from the probe tip 127, it is possible to induce the separation of the reagent R from the probe tip 127. That is, even in a case where the reagent R is in a minute amount, the reagent R can be made easier to separate from the probe tip 127.

Referring to the description of the flowchart, in step S106, the analysis function 152 causes the sensor 135 to irradiate light toward the reaction vessel 122, and based on the light detection data of the transmitted light or the scattered light of the irradiated light, the analysis function 152 calculates the concentration or the activity value of the measurement target substance, or calculates the time required for the concentration or the activity value to change.

Next, in step S108, the analysis function 152 determines whether the sample and the reagent have been sufficiently stirred, based on the calculated concentration, activity value, time, or the like. For example, in a case where the concentration or the activity value of the measurement target substance is equal to or less than a threshold, or in a case where the time required for the concentration or the activity value to change is equal to or less than a predetermined time, the analysis function 152 may determine that the sample and the reagent have not been sufficiently stirred.

In a case where the sample and reagent have not been sufficiently stirred (NO in step S108), the process proceeds to step S110. In step S110, the output control function 153 outputs an error message via the output interface 113. In a case where the sample and the reagent have been sufficiently stirred (YES in step S108), step S110 may be omitted.

Next, in step S112, the analysis function 152 discards the mixture in the reaction vessel 122, and cleans the reaction vessel 122, the reagent dispensing probe 125, and the sample dispensing probe 131. This completes the processing of the flowchart.

According to the embodiment described above, the analysis apparatus 100 includes the sample dispensing probe 131, the reagent dispensing probe 125, and the processing circuitry 150. The sample dispensing probe 131 aspirates a sample from a sample container 130, and dispenses the aspirated sample into a reaction vessel 122 on the reaction disk 121. The reagent dispensing probe 125 aspirates a reagent from a target reagent container 124 containing the reagent to be reacted with the sample, among the plurality of reagent containers 124 on the reagent storage table 123, and dispenses the aspirated reagent into the reaction vessel 122 on the reaction disk 121.

The processing circuitry 150 controls the sample dispensing probe 131 such that a sample is dropped into the reaction vessel 122 having a water-repellent concave portion. Furthermore, the processing circuitry 150 controls the reagent dispensing probe 125 such that a reagent is dropped onto the sample that has been dropped into the concave portion. As a result, the Marangoni effect (Marangoni convection) is produced in the reaction vessel 122, whereby the sample and the reagent are stirred, and a mixture of the sample and the reagent is produced. In this manner, by stirring the sample and the reagent through the Marangoni effect, the mixing ratio of the sample and the reagent can be improved.

### Other Embodiments

Other embodiments will be described below. According to the embodiment describe above, when a sample is analyzed using the analysis apparatus 100 including the dispensing unit 120, the number of vertical movements of the reagent dispensing probe 125 is determined based on the type of reagent to be reacted with the sample; however, the embodiment is not limited to this example. For example, when a sample is analyzed using a point of care (POC) device or a micro electro mechanical systems (MEMS) device (for example, μTAS, Lab on a chip, or the like), the number of vertical movements of the probe may also be determined based on the type of reagent to be reacted with the sample. That is, the method of the present embodiment can also be applied to a POC device or a MEMS device.

In addition, according to the embodiment describe above, the analysis apparatus 100 irradiates light onto the reaction vessel 122, in which the mixture of the sample and the reagent has been produced, and detects the transmitted light or the scattered light of the irradiated light. However, the embodiment is not limited to this example. For example, the mixture may be taken out from the reaction vessel 122 and transferred to another location (for example, drawn into a fine glass tube). In this way, the mixture can be irradiated with light at a different location, and the concentration or the activity value of the measurement target substance can be calculated, or the time required for the change in concentration or activity value can be calculated, based on the transmitted light or the scattered light of the irradiated light.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A specimen analysis apparatus comprising:
a first probe configured to aspirate a liquid biological sample from a sample container in which the biological sample is contained and dispense the aspirated biological sample;
a second probe configured to aspirate a liquid reagent from a reagent container in which the reagent is contained and dispense the aspirated reagent; and
processing circuitry configured to control the first probe such that the biological sample is dropped into a water-repellent concave portion and control the second probe such that the reagent is dropped into the concave portion.

2. The specimen analysis apparatus according to claim 1, wherein the processing circuitry controls the first probe such that the biological sample is dropped into the concave portion and controls the second probe such that the reagent is dropped onto the biological sample that has been dropped into the concave portion.

3. The specimen analysis apparatus according to claim 2,
wherein the processing circuitry controls an amount of the reagent to be dispensed from a tip of the second probe, and
wherein the processing circuitry controls a distance between a surface of the biological sample having a spherical shape and the tip of the second probe, based on a diameter of the reagent to be dispensed from the tip of the second probe.

4. The specimen analysis apparatus according to claim 3, wherein the processing circuitry controls the distance such that the distance becomes a same length as the diameter of the reagent.

5. The specimen analysis apparatus according to claim 2, wherein the processing circuitry causes the second probe to dispense the reagent from a tip of the second probe such that an amount of the reagent is 7 microliters (μL) or less.

6. A dispensing apparatus comprising:
a first probe configured to aspirate a liquid sample from a sample container in which the sample is contained and dispense the aspirated sample;
a second probe configured to aspirate a liquid reagent from a reagent container in which the reagent is contained and dispense the aspirated reagent; and
processing circuitry configured to control the first probe such that the sample is dropped into a water-repellent concave portion and control the second probe such that the reagent is dropped into the concave portion.

7. A specimen analysis method comprising:
causing a first probe to aspirate a liquid biological sample from a sample container in which the biological sample is contained and dispense the aspirated biological sample;
causing a second probe to aspirate a liquid reagent from a reagent container in which the reagent is contained and dispense the aspirated reagent; and
causing processing circuitry to control the first probe such that the biological sample is dropped into a water-repellent concave portion and to control the second probe such that the reagent is dropped into the concave portion.
